(19) United States
(12) Patent Application Publication
(10) Pub. No.: US 2008/0070547 A1
(43) Pub. Date: Mar. 20, 2008

(54) Method for Radio Transmission in a Radio Cell of an Alarm System

(75) Inventor: Karlheinz Schreyer, Wolfratshausen (DE)

Correspondence Address: LERNER GREENBERG STEMER LLP, P O BOX 2480, HOLLYWOOD, FL, 33022-2480, US

(73) Assignee: Siemens Building Technologies Fire & Security Products GmbH & Co.oHG, Munchen (DE)

(21) Appl. No.: 11/857,032

(22) Filed: Sep. 18, 2007

(30) Foreign Application Priority Data
Sep. 18, 2006 (EP) EP06120817

(51) Int. Cl. H04M 11/04

(52) U.S. Cl. 455/404.2

(57) ABSTRACT

A method for radio transmission in a radio cell of an alarm system uses a time slot for communication between users or with a radio cell central unit that is subdivided into a first main area and a second main area. At least two of the users send routine signals to the radio cell central unit within the first main area, before detector data is transferred to the radio cell central unit or to another user in the second main area. This enables more users to be operated in the radio cell, with the reaction time remaining the same and lower power consumption of the peripheral elements.

### CROSS-REFERENCE TO RELATED APPLICATIONS

This application claims the priority, under 35 U.S.C. §119, of European application EP 06 120 817, filed Sep. 18, 2006; the prior application is herewith incorporated by reference in its entirety.

### BACKGROUND OF THE INVENTION

1. Field of the Invention

The invention relates to a method for radio transmission in a radio cell of an alarm system in which detector data is transferred from users to a radio cell central unit as well as addresses identifying the users. In this manner the radio cell central unit on the basis of the detector data received, can control measures to counter a danger, with the transmission being undertaken in a time frame predetermined by a system clock assigned to the radio cell central unit, and with the users periodically sending in turn in the predetermined time frame a routine signal for checking the system integrity in an assigned detector time slot to the radio cell central unit.

Radio alarm systems include a plurality of users in a radio cell, such as alarm sensors which transfer an alarm message over the radio link to a radio cell central unit in the event of danger (fire, intrusion) being detected. In such cases the signal can be transmitted directly to the main central unit (then the alarm system only has one radio cell) or via radio cell central units (so-called “clusterheads”) as relay stations to the main central unit. In the main central unit further measures can be taken to deal with the danger (sending alarms to the fire department or the police). The alarm sensors in such cases contain a transmit and receive device and, to enable them to be used in inaccessible places, should be able to be operated as independently as possible, i.e. with a battery and not through a cable connection to a power network. To this end all components of the alarm sensor are to be configured for maximum power saving and the components should also only be switched on at specific times and not be constantly in operation. Further peripheral elements, such as control panels for example, should be able to communicate with the radio cell central unit as users in the alarm signaling system via a radio transmission link and are thus also to be configured for power saving like the users embodied as alarm sensors.

In current radio systems the radio cells are relatively small (approximately 10 users). The connection between the radio cell central unit and the main central unit which may be required is frequently implemented using conventional wiring. Because of the resulting large number of radio cells this can hardly be referred to as a wireless system. The time available for a radio cell with 30, 50 or 100 users is generally subdivided into two periods of time for radio transmission, with a system integrity of the radio cell being checked in the first period and in a second period there being an exchange of data between the users and the radio cell central unit. A method for bidirectional radio transmission in an alarm system is known from published, European patent EP 1 398 910 A1 (corresponding to published U.S. patent application No. 2006/0040670 A1) in which peripheral elements as users send a routine signal in turn to a central facility within a time frame predetermined by a system clock in order to check the integrity of the system, the central unit sends out an acknowledgement signal to the peripheral elements for system synchronization with the system clock after receiving the routine signal. A peripheral element that is ready to send evaluates the radio traffic between the other peripheral elements and the central unit on receipt of the acknowledgement signal and subsequently transfers to the central unit the detector data to be sent. In this system all time slots have the same structure and are evenly distributed. Because of the 100 seconds fault detection time predetermined in Specification EN 54 a block of all time slots repeats after 30 seconds. Thus an irregularity in the radio cell is detected after this half minute at the latest. The alarm system then still has 60 seconds to rectify the problem.

A greater number of users in a radio cell could be achieved by an increased data transfer rate, but this would be at the cost of decreased sensitivity. A further option would be to shorten the time slots, but this would lead to a linear increase in the power consumption of the peripheral elements and would thus reduce the battery life accordingly. In addition it would also be possible to increase the 30-second block, but doing so would reduce the time available to the alarm system for rectifying a possible irregularity in order to meet the requirements of EN 54.

### BRIEF SUMMARY OF THE INVENTION

It is accordingly an object of the invention to provide a method for radio transmission in a radio cell of an alarm system which overcomes the above-mentioned disadvantages of the prior art methods of this general type, which, while retaining the power consumption of the users and the reaction time, increases the possible number of users in the radio cell.

With the foregoing and other objects in view there is provided, in accordance with the invention, a method for radio transmission in a radio cell of an alarm system. The method includes transmitting detector data from users to a radio cell central unit as well as addresses identifying the users, so that the radio cell central unit on a basis of the detector data received, can control measures to counter a danger. The transmitting step is undertaken in a predetermined time frame determined by a system clock assigned to the radio cell central unit. A routine signal is periodically sent in turn in the predetermined time frame for checking system integrity in an assigned detector time slot to the radio cell central unit by the users. After a transmission of the routine signal by a first user, at least one second user sends a further routine signal to the radio cell central unit, and only subsequently does a user wishing to send, sends its detector data to the radio cell central unit or to another user.

In this case, before transmission of the detector data to the radio cell central unit or to further users, at least two users can transfer their routine signals to the radio cell central unit. The invention thus utilizes the knowledge that in the period of time available for the transmission of detector data, frequently no detector data is transmitted, so that the length of this period of time can be reduced. The main central unit or the radio cell central unit can also transfer information to the users in the period after transmission of the routine signals. In such cases routine signals can for example be used to check the integrity of the radio cells or of the alarm system, but can also be other system-relevant messages such as logging-on or logging-off of users, the transmission of new routes or the determination or transmission of connection qualities.

In the advantageous embodiment of the method, the communication between the radio cell central units and the users is undertaken in periodically repeating time slots, with these time slots containing a first main area for the transmission of the routine signals and a second main area for the transmission of the detector data. This combination results in that the second main area available for the transmission of the detector data is not split up, so that for example longer telegrams can also be transmitted.

The fixed assignment of the users to respective alarm time slots for the sending out of the routine signals for system integrity checking is advantageously safeguarded by only the partners involved in the data exchange having to activate the transmit and receive units for transmitting and receiving, which contributes to reducing power consumption.

Avoiding further communication in the time slots provided for the transmission of the routine signals ensures that the system integrity checking proceeds without interruption.

In the preferred embodiment of the method, in which all users know the subdivision of the first main area, this knowledge can be used by the peripheral elements for synchronization purposes, and thus a user wishing to send can determine the point in time of a possible transmission in the second main area.

In the advantageous embodiment of the method, collisions between users wishing to send can be restricted since fixed points in time are defined in the second main area at which the users wishing to transmit can transfer their detector data and thus the number of parallel transmission attempts can be reduced.

A simple option for synchronization of the users is provided by obtaining the necessary time information from the exchange of data for checking the system integrity.

Joint acknowledgement of a number of routine signals by the radio cell central unit at the end of the first main area, allows further time to be saved since each routine signal is not acknowledged individually.

Other features which are considered as characteristic for the invention are set forth in the appended claims.

Although the invention is illustrated and described herein as embodied in a method for radio transmission in a radio cell of an alarm system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTIONS OF THE SEVERAL VIEWS OF THE DRAWING

FIG. 1 is a schematic illustration of a structure of a radio alarm system according to the invention; and

FIG. 2 is an illustration showing a transmission scheme for communication between users and a radio cell central unit.

### DETAILED DESCRIPTION OF THE INVENTION

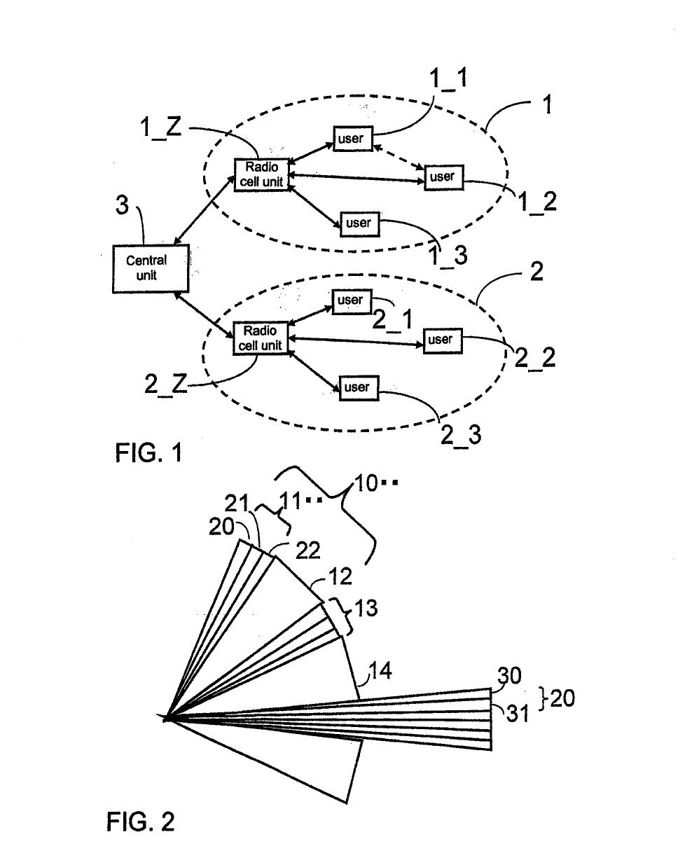

Referring now to the figures of the drawing in detail and first, particularly, to FIG. 1 thereof, there is shown a schematic diagram of an alarm system containing a first radio cell 1 and a second radio cell 2, with both radio cells 1, 2 communicating with a main central unit 3. FIG. 1 shows three users 1_1, 1_2, 1_3, 2_1, 2_2, 2_3 for the first and the second radio cell respectively (naturally there can be very many more users present in radio cells 1, 2, for example, 30 to 100) as well as a radio cell central unit 1_Z, 2_Z in each case. The radio cell central unit is frequently also referred to as a “cluster head”.

In such cases users 1_1, 1_2, 1_3, 2_1, 2_2, 2_3 as a rule generally have in the known way of alarm-side transmit and receive devices for wireless communication with central unit-side transmit and receive devices of radio cell central unit 1_Z, 2_Z (not shown) as well as detection devices also not shown in the diagram, for example infrared alarms for intrusion detection or smoke or heat sensors for fire detection. Operating elements are also provided as users 1_1, 1_2, 1_3, 2_1, 2_2, 2_3, the detection device is used in this case for example for detecting commands entered at a control element, which are intended to be passed on to the radio cell central unit 1_Z, 2_Z or to the main central unit 3. Users 1_1, 1_2, 1_3, 2_1, 2_2, 2_3 can also communicate with each other, as shown by the example dashed-line connections in FIG. 1. The radio cell central units 1_Z, 2_Z likewise send information to the users 1_1, 1_2, 1_3, 2_1, 2_2, 2_3, for example acknowledgement signals or requests for explicit transmission of particular detector data, in order for example, in the case of an event signaled by a user 1_1, 1_2, 1_3, 2_1, 2_2, 2_3, to interrogate adjacent users 1_1, 1_2, 1_{—, 2}_1, 2_2, 2_3. The radio cell central units 1_Z, 2_Z communicate wirelessly or by wire with the main central unit 3, in which the further processing of the alarm signal is undertaken. Thus the fire department can be notified for example in the case of a fire, fire doors possibly closed and an alarm signal triggered in a building in which the smoke sensors are located for example.

FIG. 2 shows a diagram depicting the typical transmission scheme between the radio cell central units 1_Z, 2_Z and users 1_1, 1_2, 1_3, 2_1, 2_2, 2_3. If for example a block of 30 seconds is used for the entire alarm system, this block is subdivided into 20 time slots 10 each of 1.5 seconds duration. In this scheme each time slot 10 has a first main area 11 for system integrity checking and a second main area 12 for a general transmission of telegrams between the users 1_1, 1_2, 1_3, 2_1, 2_2, 2_3 and the radio cell central units 1_Z, 2_Z or between the individual users. The first main area 11 in the example shown lasts 0.5 seconds and in this case provides space for three alarm time slots 20, 21, 22 for the transmission of routine signals between three of the users 1_1, 1_2, 1_3, 2_1, 2_2, 2_3 and the radio cell central unit 1_Z, 2_Z. The first main area 11 is followed by the second main area 12 that lasts 1 second. In the second main area 12 the detector data is transmitted (for example a heat event detected by an infrared detector or smoke detected by a smoke detector) from the users 1_1, 1_2, 1_3, 2_1, 2_2, 2_3 to the respective radio cell central unit 1_Z, 2_Z, or to other users. The radio cell central unit 1_Z, 2_Z can also use the second main area 12 in order to communicate with users 1_1, 1_2, 1_3, 2_1, 2_2, 2_3, for example to cause further subscribers to transmit detector data if an adjacent user 1_1, 1_2, 1_3, 2_1, 2_2, 2_3 has signaled an event. The radio cell central unit 1_Z, 2_Z then transmits this information for example to the main central unit 3, communication between the radio cell central units 1_Z, 2_Z can be wireless or over wires. A priority can be transmitted as well within the routine signal that is needed for the subsequent detector data transmission and with high priority is also taken into account in a collision resolution process where there are transmission requests by a number of users wishing to transmit.

If not all possible free time slots in the first main area 11 are used by users 1_1, 1_2, 1_3, 2_1, 2_2, 2_3, since for example fewer users than the maximum number possible are present in a radio cell 1, 2, then the corresponding time slots remain free. The overall structure of combined time slots in the first main area 11 for the transmission of routine signals and acknowledgement signals and of a second main area 12 is retained in this case.

The second main area 12 is followed by a further first main area 13, in which the routine signals of further users of the radio cell are exchanged, this area in its turn being followed by a further second main area for exchange of detector data, etc. until all subscribers 1_1, 1_2, 1_3, 2_1, 2_2, 2_3 have transmitted their routine signals to the radio cell central unit 1_Z, 2_Z. The first main area 11 can be adapted in this case so that the duration of the individual detector time slots 20, 21, 22 is adapted to the number of subscribers 1_1, 1_2, 1_3, 2_1, 2_2, 2_3 in the radio cell 1, 2.

The individual time slot 20, 21, 22 is subdivided in this case for example into a routine message time slot 30 and an acknowledgement time slot 31, with the routine message time slot 30 being 50 ms long for example and the acknowledgement time slot 100 ms long. During the routine message time slot 30 a transmitter of the detector-side transmit and receive device transmits and a receiver of the central unit-side transmit and receive device waits to receive the routine signal. In the acknowledgement time slot 31 a transmitter of the central unit-side transmit and receive device sends an acknowledgement signal, and a receiver of the detector-side transmit and receive device waits to receive the acknowledgement signal. A telegram for the routine signal is for example 8 to 16 bits long, the acknowledgement signal of the radio cell central unit 1_Z, 2_Z is for example 120 bits long.

The acknowledgement signal of the radio cell central unit 1_Z, 2_Z can also occur jointly at the end of the first main area 11 for all routine signals of this first main area 11, which allows further a time saving to be made since fewer acknowledgement signals are transmitted.

In the case in which detector data is not transmitted, users 1_1, 1_2, 1_3, 2_1, 2_2, 2_3 only switch on their transmitters to send out the routine signals and their receivers only to receive the acknowledgement signal.

In this case it is advantageous for the individual detector time slots 20, 21, 22 to be permanently assigned to the users 1_1, 1_2, 1_3, 2_1, 2_2, 2_3, since then the users 1_1, 1_2, 1_3, 2_1, 2_2, 2_3 know the times at which to switch their transmitters and receivers on and off. If the fixed assignment of the detector time slots 20, 21, 22 is known to all users 1_1, 1_2, 1_3, 2_1, 2_2, 2_3, the users 1_1, 1_2, 1_3, 2_1, 2_2, 2_3 also know the point in time for the transmission of the defector data and are thus all synchronized with each other.

The second main area 12 can also be used in this case so that the users 1_1, 1_2, 1_3, 2_1, 2_2, 2_3 are each assigned fixed points in time within the second main area 12, at which the users start to transmit their detector data. This enables the number of collisions during the transmission of detector data to be reduced right from the outset.

By collecting together the transmission of the routine signals from a number of users 1_1, 1_2, 1_3, 2_1, 2_2, 2_3 the inventive method in the example enables up to 60 users 1_1, 1_2, 1_3, 2_1, 2_2, 2_3 to be disposed in the radio cell 1, 2 while retaining the reaction time of the system and the power consumption of the users 1_1, 1_2, 1_3, 2_1, 2_2, 2_3, which, in the case without transmission of the detector data, only have to switch on their transmitters to send out the routine signal and their receivers to receive the acknowledgement signal. Shortening the length or increasing the number of detector time slots 20, 21, 22 in the first main area 11 allows the number of users 1_1, 1_2, 1_3, 2_1, 2_2, 2_3 in the radio cell 1, 2 to be further increased.

1. A method for radio transmission in a radio cell of an alarm system, which comprises the steps of:
transmitting detector data from users to a radio cell central unit as well as addresses identifying the users, so that the radio cell central unit on a basis of the detector data received, can control measures to counter a danger;
undertaking the transmitting step in a predetermined time frame determined by a system clock assigned to the radio cell central unit;
periodically sending in turn in the predetermined time frame a routine signal for checking system integrity in an assigned detector time slot to the radio cell central unit by the users; and
after a transmission of the routine signal by a first user, at least one second user sending a further routine signal to the radio cell central unit, and only subsequently does a user wishing to send sends its detector data to the radio cell central unit or to another user.

2. The method according to claim 1, which further comprises configuring the predetermined time frame so that periodically repeating time slots are used which are made up of a first main area and a second main area, with at least two of the users able to transmit the routine signals within the first main area to the radio cell central unit and the second main area being available for transmission of the detector data.

3. The method according to claim 2, which further comprises dividing the first main area into detector time slots and each of the users in the alarm system is assigned a fixed one of the detector time slots and a respective user transfers its routine signal to the radio cell central unit in the assigned fixed detector time slot.

4. The method according to claim 3, wherein no detector data is communicated in the assigned fixed detector time slots.

5. The method according to claim 3, which further comprises notifying all of the users in the alarm system about which of the users are using which of the fixed detector time slots.

6. The method according to claim 2, wherein within the second main area a precisely-defined point in time is agreed to, at which a user wishing to send can establish contact with another user or to the radio cell central unit.

7. The method according to claim 1, which further comprises obtaining time information required for synchronization between the users from an exchange of data by the routine signals.

8. The method according to claim 2, wherein the radio cell central unit, after receiving all of the routine signals of all of the users sent out in the first main area, sends out a joint acknowledgement signal to all of the users.
